(19) United States
(12) Patent Application Publication
(10) Pub. No.: US 2006/0007915 A1
(43) Pub. Date: Jan. 12, 2006

(54) Connecting a VOIP phone call using a shared POTS line

(76) Inventor: Andrew Frame, San Francisco, CA (US)

Correspondence Address: CARR & FERRELL LLP, 2200 GENG ROAD, PALO ALTO, CA, 94303, US

(21) Appl. No.: 10/888,603

(22) Filed: Jul. 9, 2004

(51) Int. Cl. H04L 12/66

(52) U.S. Cl. 370/352

(57) ABSTRACT

A decentralized architecture allows a plain old telephone system (POTS) line to be shared for use. Routing logic is handled by a voice over Internet protocol (VOIP) control system and by logic in an initiating analog telephone adapter (ATA). A destination ATA is selected based upon the phone number of a destination phone. Routing information for a destination ATA is communicated to the initiating ATA, and the initiating ATA communicates a media stream to the destination ATA. The system and method enables lower cost routing than currently available, relieves a caller at an initiating phone from having to select whether to use VOIP or the PSTN, and relieves the caller from dialing special phone numbers.

### BACKGROUND OF THE INVENTION

1. Field of the Invention

This invention relates generally to voice over Internet protocol (VOIP) technology, and particularly to connecting (i.e., terminating, making, or completing) a VOIP phone call using a shared plain old telephone system (POTS) line.

2. Description of the Background Art

In a public switched telephone network (PSTN), an initiating phone connects to a circuit switch and the PSTN via a first POTS line. A destination phone connects to the circuit switch and the PSTN via a second POTS line. The circuit switch electrically connects the initiating phone to the destination phone over the PSTN. The electrical connection is maintained for the entire duration of a phone call between the initiating phone and the destination phone. The electrical connection in the PSTN is commonly referred to as “circuit switched.” A problem with the PSTN is that because much of a conversation is silence, maintaining the electrical connection for the duration of the phone call wastes available bandwidth in the circuit switch.

VOIP is a technology that permits phone calls to be carried over the Internet as opposed to over the PSTN. In VOIP, a device known as an analog telephone adapter (ATA) or media gateway serves as an interface between an analog phone and the packet-based Internet. The ATA may be a standalone device or may be incorporated into another device such as a cordless phone base station or broadband modem. An initiating ATA converts analog signals from an initiating phone into packets using a voice codec (coder/decoder) algorithm. At the destination phone, to receive an incoming VOIP phone call, a destination ATA receives packets into a buffer and uses the same codec algorithm to convert the packets back into analog signals.

Typically, ATAs provide VOIP functionality via a connection to a broadband modem, such as through a cable Internet or a digital subscriber line (DSL) connection to the Internet. Typically, ATAs provide a foreign exchange subscriber (FXS) port to connect to an analog phone. As a backup for the VOIP service and for cases such as 911, some ATAs provide a Foreign Exchange Office (FXO) interface to connect to the PSTN. To provide VOIP service to a destination phone not directly connected to the Internet via a dedicated ATA, VOIP service providers (i.e., Internet telephony service providers or ITSPs such as Level 3 Communications, Inc.) offer connectivity from IP to the PSTN. ITSPs typically utilize large, centralized, multiple-port IP-to-PSTN media gateways.

A caller at the initiating phone with an ATA incorporating an FXO port must choose whether to use either VOIP to place the phone call over the Internet, or the FXO interface to place the phone call through the PSTN. For example, the caller may press the “#” key before dialing a phone number of the destination phone to choose VOIP. Accordingly, a problem with VOIP is that the initiating caller must dial additional digits or characters to choose between using VOIP or the PSTN.

A problem with the caller using some ITSPs is that the caller must first dial a special number to call in to one of the ATAs of the VOIP service provider, and the caller must then enter the phone number of the destination phone. This is referred to as two-stage dialing. A further problem with VOIP through an ITSP is that because the ITSP must pay service fees to PSTN operators, the ITSP typically charges significant termination and access fees to the caller at the initiating phone for service to destination phones via the PSTN.

Therefore, a need exists in industry to address the aforementioned deficiencies and inadequacies.

### SUMMARY OF THE INVENTION

A system for connecting a voice over Internet protocol (VOIP) phone call using a shared plain old telephone system (POTS) line comprises an initiating analog telephone adapter (ATA), a VOIP control system, and a destination ATA. The initiating ATA includes an FXS port for connecting to an initiating telephone and for receiving a phone number of a destination phone therefrom, an FXO port for interfacing to a public switched telephone network (PSTN) via the POTS line, and a port for connecting to the Internet. The FXO port is configured to connect either the initiating phone or an incoming VOIP phone call from another ATA to the PSTN. The POTS line coupled to the FXO port is thus shared by the initiating phone and the incoming VOIP phone call. The VOIP control system is connected to the Internet, and includes a call manager server and a proxy server. The proxy server is configured to receive a signaling message including the phone number of the destination phone from the initiating ATA, and communicate the phone number to the call manager server. The call manager server is configured to select the destination ATA that is in the same local calling area of the destination phone by comparing the phone number of the destination phone to a database and communicate routing information for the destination ATA to the proxy server. The proxy server is further configured to communicate the routing information for the destination ATA to the initiating ATA.

A method for connecting the VOIP phone call using the shared POTS line comprises initiating the VOIP phone call to the destination phone in the initiating ATA, transmitting the phone number of the destination phone to the VOIP control system, selecting the destination ATA that is in the same local calling area of the destination phone from a plurality of ATAs, communicating routing information for the destination ATA to the initiating ATA, placing a call to the phone number of the destination phone over the shared POTS line in the destination ATA, and connecting the VOIP phone call from the initiating ATA to the destination ATA.

A decentralized architecture allows the POTS line to be shared for use. Routing logic is handled by the VOIP control system and by logic in the ATAs. The architecture enables lower cost routing (i.e., termination) than currently available. Selecting the destination ATA based upon the phone number of the destination phone and communicating routing information for the destination ATA to the initiating ATA relieves a caller at the initiating phone from having to select whether to use VOIP or the PSTN, and relieves the caller from dialing special phone numbers. The caller at the initiating phone is not required to choose between making an Internet VOIP phone call or a PSTN phone call at the initiating ATA connected to the initiating phone.

### BRIEF DESCRIPTION OF THE DRAWINGS

FIG. 1 illustrates a telecommunications system spanning the Internet and the PSTN, in one embodiment of the invention;

FIG. 2 illustrates an exemplary architecture of a VOIP control system for connecting a VOIP phone call using a shared POTS line, in one embodiment of the invention;

FIG. 3 illustrates an exemplary user database for connecting a VOIP phone call using a shared POTS line, in one embodiment of the invention;

FIG. 4 illustrates an exemplary ATA for connecting a VOIP phone call using a shared POTS line, in one embodiment of the invention;

FIG. 5 illustrates an exemplary method for connecting PSTN and VOIP phone calls using a shared POTS line, in one embodiment of the invention; and

FIG. 6 illustrates an exemplary method for registering an ATA, in one embodiment of the invention.

### DETAILED DESCRIPTION

The invention provides systems and methods for connection and routing logic to automatically decide whether to use the Internet or a public switched telephone network (PSTN) to connect a phone call to a destination phone over a shared plain old telephone system (POTS) line. As further detailed below, a benefit of the shared POTS line is that termination of a VOIP phone call to a destination analog telephone adapter (ATA) in the same local calling area as the destination phone is the least expensive manner to route a VOIP phone call to the destination phone.

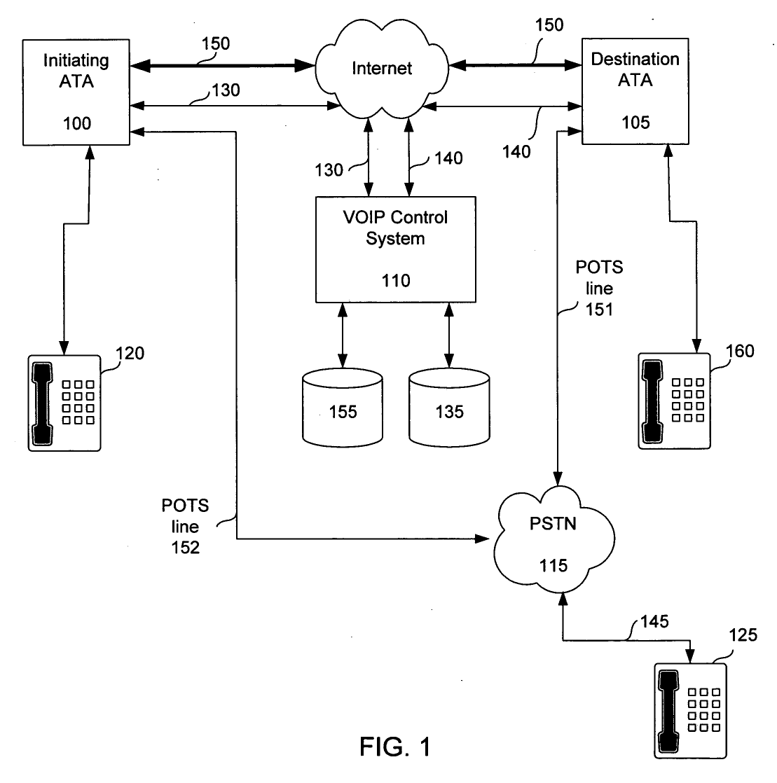

FIG. 1 illustrates a telecommunications system spanning the Internet and the PSTN, in one embodiment of the invention. Although only one initiating ATA 100 and one destination ATA 105 are depicted in FIG. 1 for clarity, a VOIP control system 110 can be coupled to numerous such ATAs. Additionally, while the following discussion refers to the initiating ATA 100 and the destination ATA 105 for ease of description, it will be appreciated that the initiating ATA 100 can also receive phone calls, and the destination ATA 105 can also initiate phone calls. The ATAs 100 and 105 are each coupled to the Internet and at least one PSTN 115 via standard POTS lines (e.g., POTS lines 151 and 152). The PSTN 115 comprises any level of the global PSTN, including, for example, a local transport network, a regional transport network, or an international transport network. The initiating ATA 100 is also coupled to an initiating phone 120. As referred to herein, a phone is any device capable of placing a phone call to a destination phone 125, and includes, for example, an analog phone, a facsimile machine, and a cellular phone. The initiating phone 120 is configured to communicate a phone number of the destination phone 125 to the VOIP control system 110 utilizing a signaling message (i.e., control message) transmitted over a signaling pathway 130.

As described in more detail below, the VOIP control system 110 is coupled to a database 135 for call routing. The database 135 contains information on appropriate cost centers for call routing, including numbering plan area (NPA) codes (i.e., area codes) and dialing prefixes (i.e., dedicated exchanges NXX). The database 135 in some embodiments comprises a LERG™ Routing Guide database available from Telecordia Technologies, Inc. The VOIP control system 110 is any combination of hardware and software configured to select the appropriate destination ATA 105 in the same local calling area as the destination phone 125 from among many such ATAs based upon the phone number of the destination phone 125. The VOIP control system 110 is further configured to verify availability of the destination ATA 105 utilizing a signaling message transmitted over a signaling pathway 140 and communicate routing information for the destination ATA 105 to the initiating ATA 100 utilizing the signaling pathway 130.

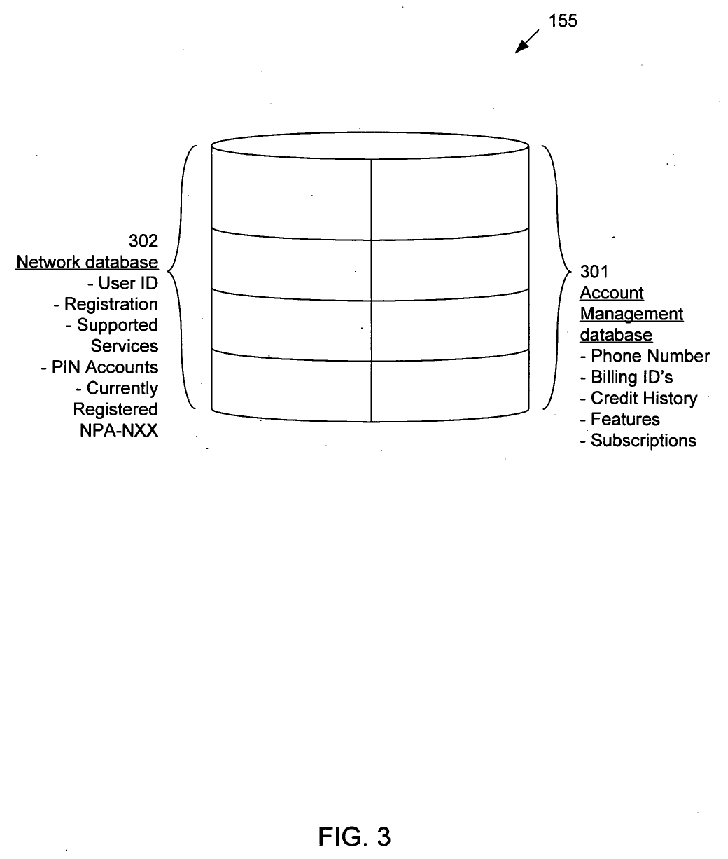

Once connected, a VOIP phone call over the Internet from the initiating phone 120 to the destination phone 125 connected to a POTS line 145 comprises a real time protocol (RTP) media stream 150 between the initiating ATA 100 and the destination ATA 105. As discussed below, a shared POTS line 151 between the destination ATA 105 and the PSTN 115 is available to be shared between a phone 160 (e.g., for a PSTN phone call from the phone 160 to the destination phone 125) and the initiating ATA 100 (e.g., for a VOIP phone call from the initiating phone 120 to the destination phone 125). In one embodiment the phone 160 may receive a phone call originating from the PSTN 115 even if the POTS line 151 is in use by another ATA. A user database 155 coupled to the VOIP control system 110 will be discussed in conjunction with FIG. 3 below.

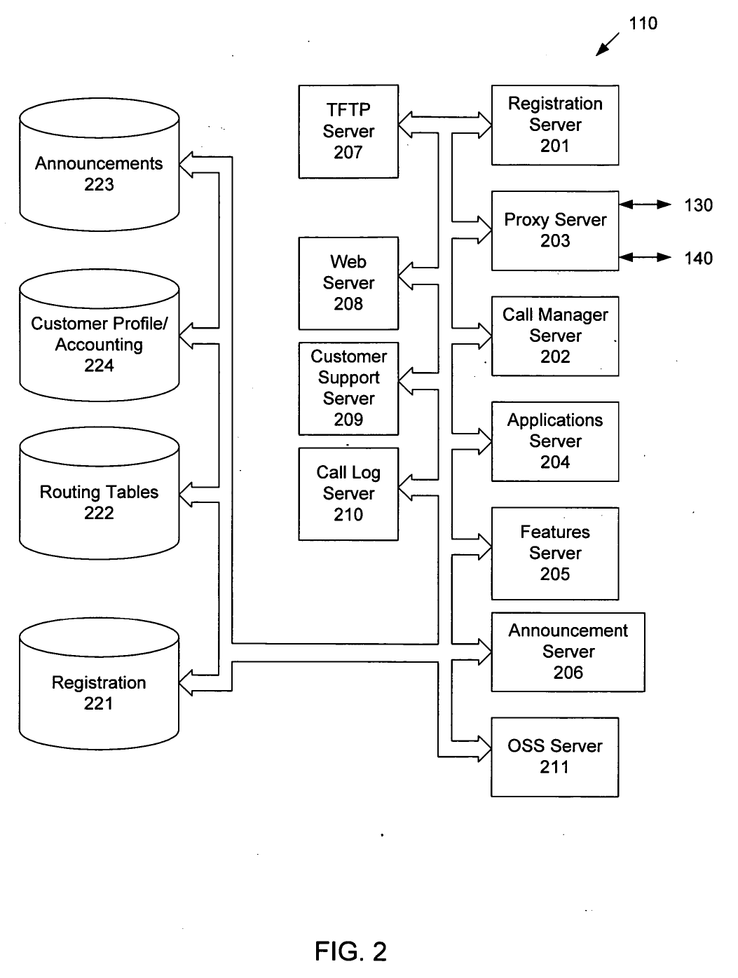

FIG. 2 illustrates a VOIP control system 110 for connecting a VOIP phone call using a shared POTS line, in one embodiment of the invention. Although the embodiment of FIG. 2 depicts individual servers 201 through 211, it will be appreciated that the servers 201-211 can be combined or distributed in various ways. For example, the servers 201-211 can be implemented in a decentralized peer-to-peer network rather than in a client-server configuration. Similarly, the separate databases 221-224 can also be combined or distributed. It will also be appreciated that the servers 201-211 and the databases 221-224 can comprise any combination of hardware and software elements.

A registration server 201 is configured to register ATAs coupled to the Internet. In one embodiment, the registration server 201 registers information from an ATA after the ATA is initially coupled to the Internet. In other embodiments, the registration server 201 receives asynchronous event notification messages from an ATA after the ATA changes state, for example, from an idle state to an in use (i.e., currently busy) state or vice-versa. In other embodiments, the registered ATAs transmit periodic status information to the registration server 201. The registration server 201 updates a registration database 221 to reflect registration and status information for each registered ATA. The registration server 201 is further configured to communicate update messages to a call manager server (i.e., a routing engine) 202 and set flags in a routing tables database 222 to reflect which ATAs are available for a phone call. For example, if a particular ATA is in use, the registration server 201 can send a message to the call manager server 202 and set flags in the routing tables database 222 to flag that the particular ATA is not available as a valid route and is unavailable to receive a phone call from another ATA.

A proxy server 203 is configured to communicate signaling messages with ATAs across the Internet. To enable call routing between ATAs, the proxy server 203 of one embodiment issues requests for call routing information from the call manager server 202. The call manager server 202 can be configured to determine appropriate call routing for connecting a VOIP phone call based upon the routing tables database 222 and the database 135 (FIG. 1). In one embodiment, routing logic of the call manager server 202 is decentralized among a number of servers or processors (not shown).

In some embodiments, an applications server 204 and a features server 205 provide advanced call features, such as, for example, “follow-me” services, services that require media stream intervention, teleconferencing services, call-forwarding, 3-way calling, and/or call waiting. Advanced call features can comprise both standard session initiation protocol (SIP) features and custom-developed features. An announcement server 206 in some embodiments provides one or more sound files, such as “.wav” files, stored in an announcements database 223 to simulate a voice response. For example, the announcement server 206 may issue a .wav file containing “your call cannot be completed” for a phone call that cannot be placed.

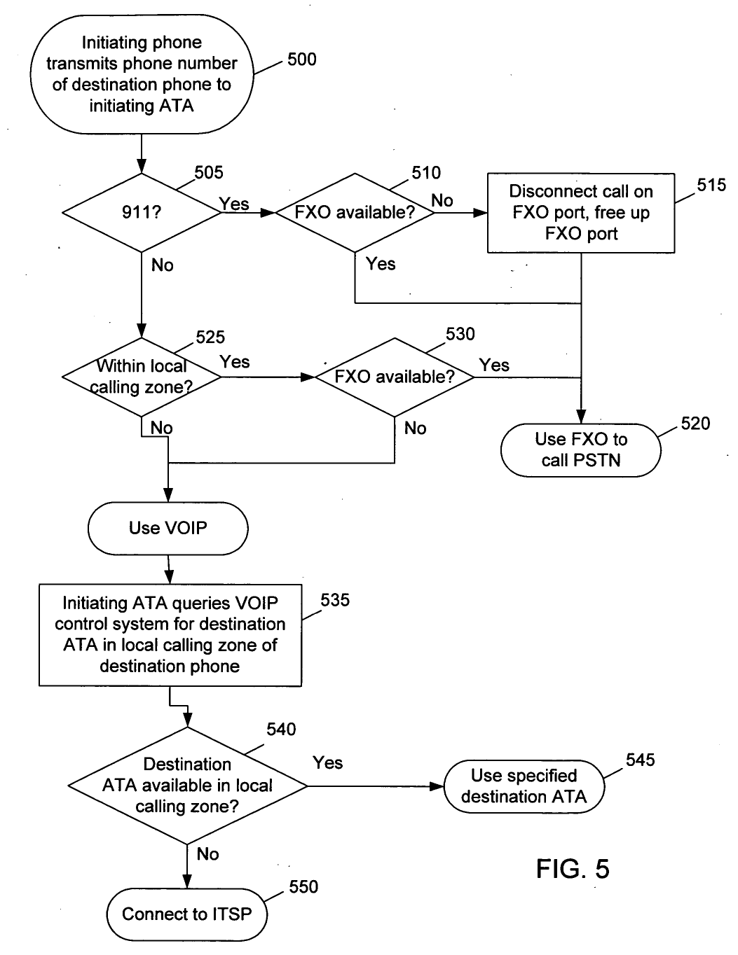

A trivial file transfer protocol (TFTP) server 207 of one embodiment is configured to download routing tables, usage profiles, and firmware updates to the registered ATAs. Routing tables are described in more detail in conjunction with FIG. 5, below. The TFTP server 207 also provides provisioning features as described below. A benefit of the TFTP server 207 is that software or firmware in the ATAs can be updated periodically or as needed, to maintain up-to-date configuration.

A web server 208 of one embodiment comprises the customer-facing part of the VOIP control system 110. The web server 208 is configured to provide web pages for the application servers 201-211 that interface to customers. The web server 208 of one embodiment provides a customer support server 209 with web pages by which the customer can communicate with the customer support server 209. The customer support server 209 of one embodiment is configured to control customer account and customer access information. The customer support server 209 supports functions such as customer relationship management (CRM) and/or online trouble resolution. For example, a customer having difficulty setting up an ATA may log into a smart knowledge base hosted on the customer support server 209 and use online chat with a technician for trouble resolution. Further, the customer support server 209 can provide a provisioning application for initial setup and service activation.

A call log server 210 of some embodiments is configured to track signaling messages and other events associated with PSTN and VOIP phone calls. For example, the call log server 210 can track a time a call is initiated and a time a call is ended. The call log server 210 can also compute a call duration. In one embodiment, each registered ATA collects such call detail information and passes the call detail information to the call log server 210. The call log server 210 can maintain the call detail information, for example, in a call detail record (CDR) file. In some embodiments, the call log server 210 advantageously supports Communications Assistance for Law Enforcement Act (CALEA) requirements, provides call logs to customers, and supports customer billing.

An operation support system (OSS) server 211 is configured to provide internal support of the servers 201-210 and the databases 221-224. In one embodiment, the OSS server 211 provides for connections between databases and servers via simple network management protocol (SNMP). A customer profile/accounting (i.e., billing account management) database 224 of one embodiment contains records detailing customer premises equipment (CPE), a summary of CDR data from the call log server 210, billing records, and customer trouble history.

FIG. 3 illustrates a user database 155 for connecting a VOIP phone call using a shared POTS line, in one embodiment of the invention. The user database 155 of this embodiment comprises two user databases tied to the registration database 221 of FIG. 2. An account management database 301 contains records of customer information, for example residence address, telephone number, billing address, trouble history, credit history, bill presentation, and subscribed features/services. A network database 302 comprises a customer profile database linked by customer ID. The network database 302 includes information such as user ID, registration information, a list of support services, personal identification numbers (PIN), and currently registered numbering plan area (NPA) codes (i.e., an area code), and central office (NXX) codes (i.e., a local number prefix), as described below in conjunction with FIG. 5.

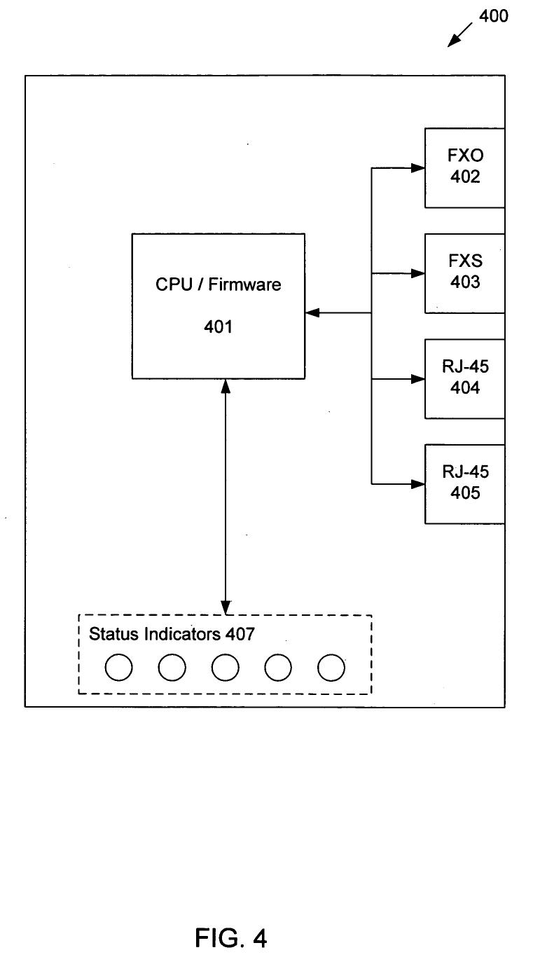

FIG. 4 illustrates an ATA 400 for connecting a VOIP phone call using a shared POTS line, in one embodiment of the invention. The ATA 400 of this embodiment (e.g., the initiating ATA 100 or the destination ATA 105) comprises CPU/firmware 401, input/output (I/O) ports 402 through 405, and status indicators (e.g., LEDs) 407. The CPU/firmware 401 of one embodiment includes memory (not shown) to store a routing table downloaded from the TFTP server 207 of FIG. 2. An FXO port 402 is configured to interface to the PSTN (e.g., PSTN 115 of FIG. 1) via a POTS line (e.g., the POTS line 152 of FIG. 1). In one embodiment, the ATA 400 includes multiple FXO ports 402. A foreign exchange subscriber (FXS) port 403 is configured to interface to an analog phone (e.g., the initiating phone 120 of FIG. 1). In one embodiment, the FXS port 403 is configured to interface to multiple analog phones, so that a single ATA can interface to all phones in a residence, for example. A first RJ-45 connector 404 provides for a wide area network (WAN) (e.g., Ethernet) interface to the Internet to communicate signaling messages with the VOIP control system 110 (FIG. 1) and media streams with other ATAs. A second RJ-45 connector 405 can optionally be provided for a local area network (LAN) interface to a personal computer, router, and/or hub. In one embodiment, the ATA 400 includes router circuitry (not shown) to provide router functions if both the WAN interface and the LAN interface are connected to external networks. Status indicators 407 provide, for example, indications of activity, power on, voicemail, and line-in use. The ATA 400 includes circuitry (not shown) to convert analog signals into packets, and a buffer and voice coder/decoder (not shown) to convert packets into analog signals. In one embodiment, high performance coder/decoder circuits (not shown) in the ATA 400 support high fidelity media transmission. In another embodiment, encryption circuitry (not shown) is included in the ATA 400 to encrypt the transmitted media stream. In other embodiments, DSP circuitry (not shown) is included in the ATA 400 so that two phone calls can be maintained simultaneously in a single ATA 400. In this embodiment, for example with respect to FIG. 1, the phone 160 may connect and transmit a media stream over the Internet to the ATA 100 and phone 120 while simultaneously, the ATA 105 receives a media stream from another ATA 400 and couples the received media stream to the POTS line 151 and the local PSTN 115.

FIG. 5 illustrates a method for connecting PSTN and VOIP phone calls using a shared POTS line, in one embodiment of the invention. The method begins in step 500 by transmitting a phone number of the destination phone 125 (FIG. 1) from the initiating phone 120 (FIG. 1) to the initiating ATA 100 (FIG. 1). The phone number comprises an International Telecommunications Union Recommendation E.164 compliant number (i.e., a ten-digit number in the U.S. PSTN). The initiating phone 120 sends a dual tone multiple frequency (DTMF) tone to the initiating ATA 100 for each digit of the phone number dialed into the initiating phone 120.

At step 505, the initiating ATA 100 determines whether the phone number comprises an emergency code, for example “911.” in the U.S. and Canada. If so, then at step 510 the initiating ATA 100 determines whether the FXO port (e.g., FXO port 402 of FIG. 4) is available. The FXO port 402 may not be available, for example, because the initiating ATA 100 is connected to the PSTN 115 (FIG. 1) in cooperation with another ATA (e.g., to place a VOIP phone call from the phone 160 of FIG. 1, in which the initiating ATA 100 performs receiving functions as described with respect to the destination ATA 105). In one embodiment, if the FXO port 402 is not available, at step 515, the initiating ATA 100 disconnects an existing call using the FXO port 402. At step 520, the initiating ATA 100 seizes the available FXO port 402 and places a “911” call to the PSTN 115. In another embodiment, at step 520, rather than disconnecting the existing call if the FXO port 402 is not available, the initiating ATA 100 reroutes the existing call to another ATA. In other embodiments, if the FXO port 402 is not available, the initiating ATA 100 and the VOIP control system 110 cooperate to reroute the existing call to another ATA. It will be appreciated that although rerouting existing calls is described with respect to “911” phone calls, rerouting may occur for any condition in which the FXO port 402 is not available.

The following steps 525-550 describe a “lowest cost route” call routing algorithm. A local PSTN route, for example, one in which both the initiating phone 120 and the destination phone 125 are within the local calling area, and the FXO port 402 of the initiating ATA 100 is not busy, is the lowest cost routing. Referring to FIG. 1, an example of a local PSTN route is shown from the initiating phone 120, across the initiating ATA 100, the POTS line 152, the PSTN 115, the POTS line 145, and to the destination phone 125. A more expensive call route is a remote PSTN route using the shared POTS line (e.g., the POTS line 151 of FIG. 1). An example of a remote PSTN route is shown in FIG. 1 from initiating phone 120, across the initiating ATA 100 to the destination ATA 105 via media stream 150, the shared POTS line 151, the PSTN 115, and to the destination phone 125. The remote PSTN route may be necessary, for example, if the FXO port 402 of the initiating ATA 100 is busy (e.g., connected to the PSTN 115 via the POTS line 152 in conjunction with reception of a VOIP phone call from another initiating ATA not shown in FIG. 1). If the FXO port 402 of the initiating ATA 100 is in use, the phone call from the initiating phone 120 to the destination ATA 105 and the destination phone 125 may be treated as a VOIP phone call. The highest cost route comprises a path (not shown) from the initiating phone 120 to a commercial ITSP through the Internet.

At step 525 of FIG. 5, if the phone number of the destination phone 125 does not comprise “911,” the initiating ATA 100 determines whether the phone number represents a destination phone 125 within the local calling area (i.e., local calling radius or zone). The determination can be made, for example, by the CPU/firmware 401 (FIG. 4) using a routing table that defines the local calling area previously downloaded from the TFTP server 207 (FIG. 2) to the initiating ATA 100. In one embodiment, the routing table comprises a subset of the database 135 of FIG. 1. For example, in the U.S. PSTN, the routing table comprises NPA and NXX codes in the local calling area of the initiating ATA 100, toll-free NPAs such as 800, 877, or 866, pay numbers such as 900 or 976, three-digit sequences such as 511, 411, or 911, and operator, international and carrier-access codes such as 0, 0+, 01, 00, 011, or 1010.

At step 530 of FIG. 5, the initiating ATA 100 determines whether the FXO port (e.g., the FXO port 402 of FIG. 4) is available. If the FXO port is available, at step 520, the initiating ATA 100 dials the phone number of the destination phone 125 via the PSTN 115. In one embodiment, the initiating ATA 100 sends an asynchronous event notification message to the registration server 201 (FIG. 2) to reflect that the initiating ATA 100 has changed status from an idle state to an in use state. In another embodiment, throughout the duration of the PSTN phone call, the initiating ATA 100 periodically sends status messages to the registration server 201. While the initiating ATA 100 is in use, the VOIP control system 110 (FIG. 1) of one embodiment flags the initiating ATA 100 as unavailable to accept a VOIP phone call from another ATA in the routing tables database 222 (FIG. 2).

If the destination phone number does not comprise a phone call within the local calling area, or if the FXO port 402 is unavailable, at step 535, the initiating ATA 100 queries the VOIP control system 110 for a destination ATA 105 in the local calling area of the destination phone 125, to establish a remote PSTN route. The initiating ATA 100 sends a SIP message via the signaling pathway 130 (FIG. 1) to communicate the phone number of the destination phone 125 to the VOIP control system 110. In some embodiments, to prevent unregistered (e.g., unsubscribed or stolen) ATAs from placing calls, the VOIP control system 110 searches the user database 155 (FIG. 1) to verify that the initiating ATA 100 is registered and properly authenticated.

At step 540, the VOIP control system 110 compares the phone number of the destination phone 125 to the database 135 (FIG. 1) to select the best available destination ATA 105 (FIG. 1) from the registered ATAs. The VOIP control system 110 determines, based upon one or more of the dialed NPA, NXX, or ten-digit phone numbers, which of the registered ATAs is available to connect the VOIP phone call. Specifically, in one embodiment, the call manager server 202 (FIG. 2) of the VOIP control system 110 determines from the routing tables database 222 which ATAs are available, and selects the available ATA as the destination ATA 105 in the same local calling area as the destination phone 125. The call manager server 202 selects the destination ATA 105 in the same local calling area as the destination phone 125 to minimize the cost of the call through the PSTN 115 to the destination phone 125. The call manager server 202 then supplies an identification of the selected destination ATA 105 to the proxy server 203 (FIG. 2). In one embodiment, the proxy server 203 of the VOIP control system 110 sends an invite message to the selected destination ATA 105 using a signaling message. The destination ATA 105 acknowledges the VOIP control system 110, and the VOIP control system 110 responds with an acknowledge message to the initiating ATA 100. If the destination ATA 105 responds that it is available, the proxy server 203 replies to the initiating ATA 100 with routing information for the destination ATA 105.

At step 545, the initiating ATA 100 sends the phone number of the destination phone 125 to the destination ATA 105. The destination ATA 105 accesses the PSTN 115 to dial the phone number of the destination phone 125. After connecting to the PSTN 115, the initiating ATA 100 transmits media stream 150 to the destination ATA 105. In one embodiment, throughout the duration of the VOIP phone call, the initiating ATA 100 and the destination ATA 105 periodically send status messages to the registration server 201. In another embodiment, when the initiating ATA 100 and the destination ATA 105 change state from idle to in use, the initiating ATA 100 and the destination ATA 105 send asynchronous event notification messages to the registration server 201. The VOIP control system 110 flags, in the routing tables database 222, the initiating ATA 100 and the destination ATA 105 as unavailable to accept a VOIP phone call from other ATAs.

In one embodiment, if no ATAs are available in the local calling area of the destination phone 125, at step 550, the VOIP phone call may connect to an ITSP. In one embodiment, if no routes are available to the destination ATA 105, the call manager server 202 requests a .wav file from the announcement server 206 (FIG. 2), such as for example, “customer not available” to provide to the initiating ATA 100. In one embodiment, if the FXO port 402 of the initiating ATA 100 is busy, phone calls to 800, 900, 511, 411, 0+, and 1010 are not routed to the destination ATA 105, but rather the initiating ATA 100 sends a busy signal to the initiating phone 120.

Selecting the destination ATA 105 based upon the phone number of the destination phone 125 and communicating routing information for the destination ATA 105 to the initiating ATA 100 shares the POTS line 151 (FIG. 1) between the initiating ATA 100 and the phone 160 connected to the destination ATA 105. The POTS line 151 is shared because the destination ATA 105 can initiate a phone call from the phone 160 to the PSTN 115, and can connect the phone call from the initiating ATA 100 to the destination phone 125, using the a single POTS line 151.

A benefit of sharing the POTS line 151 is that the phone call to the PSTN 115 from the destination ATA 105 may be a low-cost local call. Further, in the case where the shared POTS line 151 is a residential POTS line, the shared POTS line 151 is relatively unused by the phone 160 throughout the course of a day. Sharing the POTS line 151 reduces the cost of phone calls through increased utilization of existing POTS lines 151, and by placement of calls to local PSTNs 115.

Further, the caller at the initiating phone 120 is not required to choose whether to use VOIP or PSTN 115. As connection and routing logic automatically determines whether to use the Internet or the PSTN 115 to connect the call to the destination phone 125, selection of an appropriate ATA allows the VOIP phone call to be placed to the destination phone 125 that otherwise would not be VOIP-compatible, and without requiring the caller to dial additional digits or characters.

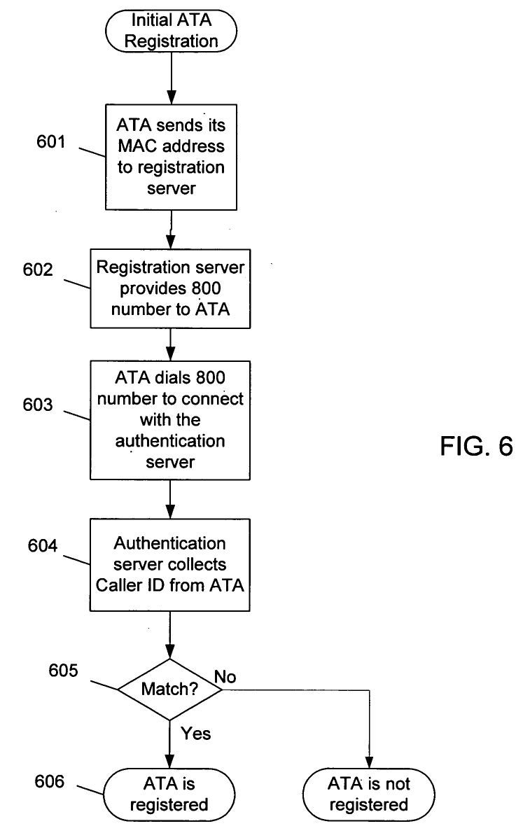

FIG. 6 illustrates a method for registering an ATA, in one embodiment of the invention. A benefit of registering ATAs is to assure that unsubscribed or stolen ATAs cannot be used for making free calls. A further benefit of registering the ATA is to dynamically determine the local calling area of the ATA. At step 601, the ATA sends its media access control (MAC) address to the registration server 201 (FIG. 2) by way of a signaling message. At step 602, the registration server 201 provides a toll-free (e.g., “800-xxx-xxxx”) number to the ATA. At step 603, the ATA dials the 800-number over the PSTN (e.g., PSTN 115 of FIG. 1) and connects to the authentication server (not shown) of the VOIP control system of FIG. 2. At step 604, the authentication server collects the caller ID from the ATA. In one embodiment, at step 605, the authentication server checks for a match between the caller ID and the local phone number of the FXO. At step 606, if the numbers match in step 605, the ATA is registered.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A VOIP control system for connecting a VOIP phone call using a shared POTS line, comprising:
a call manager server configured to select a destination analog telephone adapter coupled to the shared POTS line by comparing a phone number of a destination phone coupled to the shared POTS line to a database; and
a proxy server configured to receive a signaling message including the phone number of the destination phone from an initiating analog telephone adapter, and communicate routing information for the destination analog telephone adapter to the initiating analog telephone adapter.

2. The VOIP control system of claim 1, further comprising a trivial file transfer protocol server configured to download a routing table to the initiating analog telephone adapter.

3. The VOIP control system of claim 2, wherein the routing table comprises a portion of the database.

4. The VOIP control system of claim 1, wherein the database comprises a Telecordia database.

5. The VOIP control system of claim 1, further comprising a registration server configured to determine an availability of the destination analog telephone adapter.

6. The VOIP control system of claim 1, further comprising a call log server configured to time stamp signaling messages.

7. The VOIP control system of claim 1, wherein the shared POTS line comprises a residential POTS line.

8. The VOIP control system of claim 1, further comprising a billing account management database.

9. A method for making a VOIP phone call using a shared POTS line, the method comprising:
receiving a phone number of a destination phone coupled to the shared POTS line from an initiating analog telephone adapter;
determining if a destination analog telephone adapter coupled to the shared POTS line is available, and if so;
selecting the destination analog telephone adapter based upon the phone number of the destination phone; and
communicating routing information for the destination analog telephone adapter to the initiating analog telephone adapter.

10. The method of claim 9, wherein selecting the destination analog telephone adapter comprises comparing the phone number of the destination phone to a database.

11. The method of claim 10, wherein the database comprises a Telecordia database.

12. The method of claim 9, wherein receiving the phone number of the destination phone includes receiving a session initiation protocol message.

13. The method of claim 9, further comprising determining that the initiating analog telephone adapter is registered.

14. The method of claim 9, wherein selecting the destination analog telephone adapter comprises comparing a local calling area of the destination analog telephone adapter to the phone number of the destination phone.

15. The method of claim 9, further comprising communicating a media stream between the initiating analog telephone adapter and the destination analog telephone adapter.

16. The method of claim 9, further comprising playing an announcement message if the destination analog telephone adapter is not available.

17. The method of claim 9, further comprising connecting the VOIP phone call through an Internet telephony service provider if the destination analog telephone adapter is not available.

18. An analog telephone adapter comprising:
an FXS port for connecting to an initiating phone and for receiving a phone number of a destination phone therefrom;
logic for deciding whether to use VOIP or PSTN to connect the initiating phone to the destination phone;
an FXO port for connecting to the PSTN; and
a port for connecting to the Internet.

19. The analog telephone adapter of claim 18, wherein the logic compares the phone number of the destination phone to a routing table.

20. The analog telephone adapter of claim 18, wherein the logic includes firmware.

21. The analog telephone adapter of claim 18, wherein the logic is configured to connect the initiating phone and the destination phone using VOIP when the phone number of the destination phone represents a long distance phone number.

22. The analog telephone adapter of claim 18, wherein the logic is configured to connect the initiating phone and the destination phone using VOIP when the FXO port is in use.

23. The analog telephone adapter of claim 18, further comprising logic for dialing the phone number of the destination phone through the FXO port.

24. The analog telephone adapter of claim 18, further comprising logic for sending a session initiation protocol message including the phone number of the destination phone.

25. The analog telephone adapter of claim 18, further comprising logic for communicating a media stream to another analog telephone adapter.

26. A system for making a VOIP phone call using a shared POTS line, comprising:
a plurality of analog telephone adapters, each of the plurality of analog telephone adapters coupled to a phone and the Internet and configured to place a phone call to a public switched telephone network over a shared POTS line, the plurality including an initiating analog telephone adapter coupled to an initiating phone; and
a VOIP control system coupled to the Internet, the VOIP control system configured to
receive a phone number of a destination phone from the initiating analog telephone adapter,
select a destination analog telephone adapter from the plurality of analog telephone adapters, and
communicate routing information for the destination analog telephone adapter to the initiating analog telephone adapter.

27. The system of claim 26, wherein the initiating analog telephone adapter is further configured to communicate a signaling message to the VOIP control system and a media stream to the destination analog telephone adapter.

28. The system of claim 26, wherein the VOIP control system is further configured to select the destination analog telephone adapter based upon the phone number of the destination phone.

29. The method of claim 26, wherein the VOIP control system is further configured to select the destination analog telephone adapter by comparing a local calling area of the destination analog telephone adapter to the phone number of the destination phone.

30. The system of claim 26, wherein the initiating analog telephone adapter is configured to determine whether to use VOIP or PSTN to connect the initiating phone to the destination phone.

31. The system of claim 26, wherein the VOIP control system includes a database containing information on at least one of a numbering plan area and a dialing prefix.

32. The system of claim 26, wherein the VOIP control system is further configured to compare the phone number of the destination phone to a database.

33. The system of claim 26, wherein the VOIP control system is further configured to determine which of the plurality of analog telephone adapters are available.

34. The system of claim 33, wherein the VOIP control system is further configured to select the destination analog telephone adapters from the plurality of available analog telephone adapters.

35. A method for making a VOIP phone call using a shared POTS line, the method comprising:
initiating the VOIP phone call to a destination phone in an initiating analog telephone adapter;
transmitting a phone number of the destination phone to a VOIP control system;
selecting a destination analog telephone adapter coupled to a shared POTS line from a plurality of other analog telephone adapters;
communicating routing information for the selected destination analog telephone adapter to the initiating analog telephone adapter;
placing a call to the phone number of the destination phone over the shared POTS line in the destination analog telephone adapter; and
connecting the VOIP phone call from the initiating analog telephone adapter to the destination analog telephone adapter.

36. The method of claim 35, wherein selecting the destination analog telephone adapter comprises accessing a database.

37. The method of claim 36, wherein selecting the destination analog telephone adapter comprises comparing the phone number of the destination phone to at least one of a numbering plan area code and a dialing prefix in the database.

38. The method of claim 35, wherein transmitting a phone number of the destination phone comprises transmitting a session initiation protocol message from the initiating analog telephone adapter to the VOIP control system.

39. The method of claim 35, further comprising determining whether the initiating analog telephone adapter is registered to the VOIP control system.

40. The method of claim 35, further comprising determining which of the plurality of other analog telephone adapters are available.

41. The method of claim 35, wherein connecting the VOIP phone call comprises communicating media between the initiating analog telephone adapter and the destination analog telephone adapter.

42. A system for connecting a VOIP phone call using a shared POTS line, comprising:
an initiating analog telephone adapter including
an FXO port for connecting to an initiating telephone and for receiving a phone number of a destination phone therefrom,
an FXO port for connecting either of the initiating phone and a VOIP phone call from another analog telephone adapter to a public switched telephone network over the shared POTS line, and
a port for connecting to the Internet; and
a VOIP control system connected to the Internet and including
a call manager server configured to select a destination analog telephone adapter by comparing the phone number of the destination phone to a database; and
a proxy server configured to
receive a signaling message including the phone number of the destination phone from the initiating analog telephone adapter and
communicate routing information for the destination analog telephone adapter to the initiating analog telephone adapter.

43. The system of claim 42, wherein the initiating analog telephone adapter is further configured to transmit a media stream to the destination analog telephone adapter.

44. The system of claim 42, wherein the initiating analog telephone adapter is further configured to determine whether to use VOIP or PSTN to connect the initiating phone to the destination phone.

45. The system of claim 42, wherein the database contains at least one of a numbering plan area and a dialing prefix.
